(19) United States
(12) Patent Application Publication
(10) Pub. No.: US 2024/0146523 A1
(43) Pub. Date: May 2, 2024

(54) ACCESS CONTROL USING A BLOCKCHAIN IDENTITY AND POLICY BASED AUTHORIZATION

(71) Applicant: Unstoppable Domains, Inc., Las Vegas, NV (US)

(72) Inventors: Lisa Seacat DeLuca, Bozeman, MT (US); Richard Jacob Protus, Reno, NV (US); Aaron Quirk, Raleigh, NC (US)

(21) Appl. No.: 17/977,276

(22) Filed: Oct. 31, 2022

(51) Int. Cl. H04L 9/08; H04L 9/30; H04L 9/40

(52) U.S. Cl. CPC H04L 9/088; H04L 9/30; H04L 63/10; H04L 9/3247

(57) ABSTRACT

According to a present invention embodiment, a system for controlling access to digital content comprises one or more memories and at least one processor coupled to the one or more memories. The system verifies a blockchain identity associated with a user. An access control policy indicates blockchain identities of one or more users for controlling access to the digital content of a different user. The user is verified against the access control policy, and the user is granted a variable level of access to the digital content of the different user in accordance with the access control policy. Embodiments of the present invention further include a method and computer program product for controlling access to digital content in substantially the same manner described above.

### BACKGROUND

### 1. Technical Field

Present invention embodiments relate to computer security and access control, and more specifically, to controlling access to one or more items (e.g., applications, services, data sources, data, functionalities, operations, code, accounts, platforms, etc.) in accordance with an access control policy employing blockchain identities (e.g., non-fungible token (NFT) domain names, etc.) of users.

### 2. Discussion of the Related Art

Various analytics and data insights may be captured for distributed or decentralized applications (dApps) for Web3. Web3 generally refers to a decentralized version of the web (or Internet) based on blockchains and peer-to-peer networks. The analytics and data insights pertaining to the distributed or decentralized applications (dApps) may need to be shared with different members of a software development team or other group. However, different portions of the information may need to be shared among the different members, thereby complicating access control for limiting sharing of the information portions to the appropriate recipients. In addition, the different members may have several different accounts that may be used for member verification which adds complexity for authenticating the different members for sharing the information.

### SUMMARY

According to one embodiment of the present invention, a system for controlling access to digital content comprises one or more memories and at least one processor coupled to the one or more memories. The system verifies a blockchain identity associated with a user. An access control policy indicates blockchain identities of one or more users for controlling access to the digital content of a different user. The user is verified against the access control policy, and the user is granted a variable level of access to the digital content of the different user in accordance with the access control policy. Embodiments of the present invention further include a method and computer program product (e.g., including one or more computer readable media with instructions executable by one or more processors) for controlling access to digital content in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of an example computing device according to an embodiment of the present invention.

FIG. 3 is a flowchart of a method of creating access controls for a blockchain identity according to an embodiment of the present invention.

FIG. 4 is flowchart of a method of controlling access based on a blockchain identity and an access control policy according to an embodiment of the present invention.

FIG. 5 is a flow diagram of a method of granting and controlling access based on a blockchain identity and an access control policy according to an embodiment of the present invention.

FIG. 6 is a schematic illustration of an example graphical user interface providing data to be shared according to an embodiment of the present invention.

FIG. 7 is a schematic illustration of an example graphical user interface for providing access controls for an access control policy according to an embodiment of the present invention.

FIG. 8 is a schematic illustration of an example graphical user interface for receiving a blockchain identity to verify a user for access according to an embodiment of the present invention.

FIG. 9 is a schematic illustration of an example graphical user interface of a wallet verification for verifying a user for access according to an embodiment of the present invention.

### DETAILED DESCRIPTION

Various analytics and data insights may be captured for distributed or decentralized applications (dApps) for Web3. Web3 generally refers to a decentralized version of the web (or Internet) based on blockchains and peer-to-peer networks. The analytics and data insights pertaining to the distributed or decentralized applications (dApps) may need to be shared with members of a software development team or other group. In addition, users of an application (e.g., distributed or decentralized applications (dApps), blockchain related applications, etc.) may similarly need or desire to share information of the application with other users. Accordingly, a present invention embodiment enables sharing of information associated with a wallet address with one or more additional wallet addresses. A present invention embodiment provides access control by enabling roles, permissions, indications of items permitted for access, and/or conditions or prerequisites to be set for users of blockchain identities. A blockchain identity may include any blockchain entity that is associated with, and/or may be used to identify, a corresponding user (e.g., non-fungible token (NFT) owned by the user, a fungible token owned by the user, a non-fungible token (NFT) domain name of the user, a wallet address for the user, etc.). The blockchain identity is preferably associated with a user wallet, and information of the user may further be associated with the blockchain identity. In other words, the blockchain identity serves as a type of user identification on a blockchain to identify a particular user, and may be associated with various user information and/or attributes. A wallet associated with the blockchain identity is used to verify access rights for a user of the blockchain identity based on the user signing a message within the wallet using cryptographic keys.

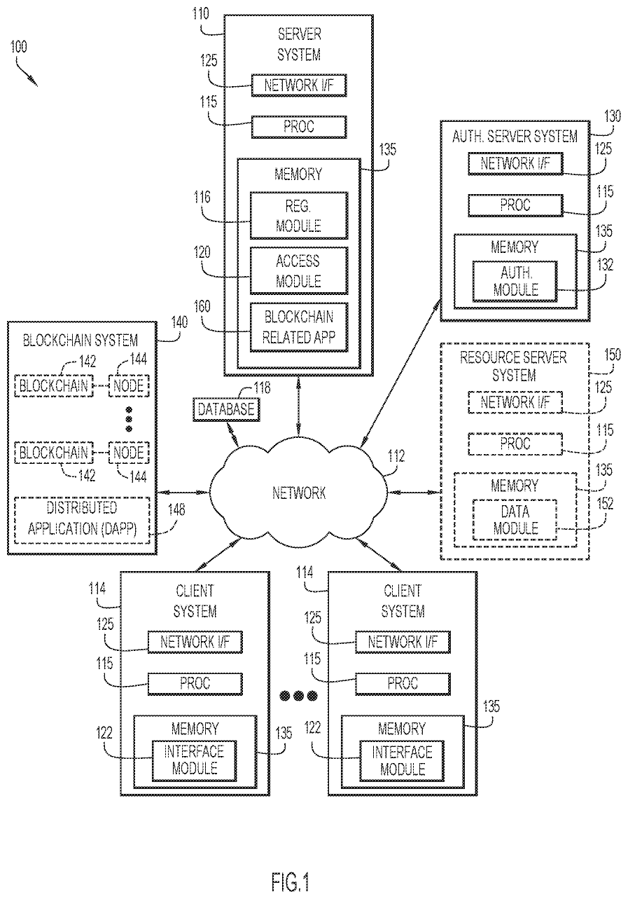

An example environment 100 for use with present invention embodiments is illustrated in FIG. 1. Specifically, environment 100 includes one or more server systems 110, one or more client or end-user systems 114, one or more authentication server systems 130, and one or more blockchain systems 140 each implementing and maintaining at least one corresponding blockchain 142. Environment 100 may further include one or more resource server systems 150. Server systems 110, client systems 114, authentication server systems 130, blockchain systems 140, and/or resource server systems 150 may be remote from each other and communicate over a network 112. The network may be implemented by any number of any suitable communications media (e.g., wide area network (WAN), local area network (LAN), Internet, Intranet, etc.). Alternatively, server systems 110, client systems 114, authentication server systems 130, blockchain systems 140, and/or resource server systems 150 may be local to each other, and communicate via any appropriate local communication medium (e.g., local area network (LAN), hardwire, wireless link, Intranet, etc.).

Server systems 110 include a registration module 116 and an access module 120. Registration module 116 interfaces with a user via client system 114 to perform blockchain or other domain name registration and/or manage crypto or other assets for users. Access module 120 may be implemented by any application or application programming interface (API), and controls access to applications and/or data based on access control policies. Client systems 114 may include an interface module 122 to provide a graphical user (e.g., GUI, etc.) or other interface (e.g., command line prompts, menu screens, etc.) that enables users to access server systems 110 for registering blockchain or other domain names, managing crypto or other assets, and managing access control policies. The interface module may include any conventional or other browser to access server systems 110.

Authentication server systems 130 include an authentication module 132 that authenticates a user as corresponding to a blockchain identity. The blockchain identity may include any blockchain entity that is associated with, and/or may be used to identify, a corresponding user (e.g., non-fungible token (NFT) owned by the user, a fungible token owned by the user, a non-fungible token (NFT) domain name of the user, a wallet address for the user, etc.). The authentication module may process requests from any entities (e.g., user, application, service, computing or other device, etc.).

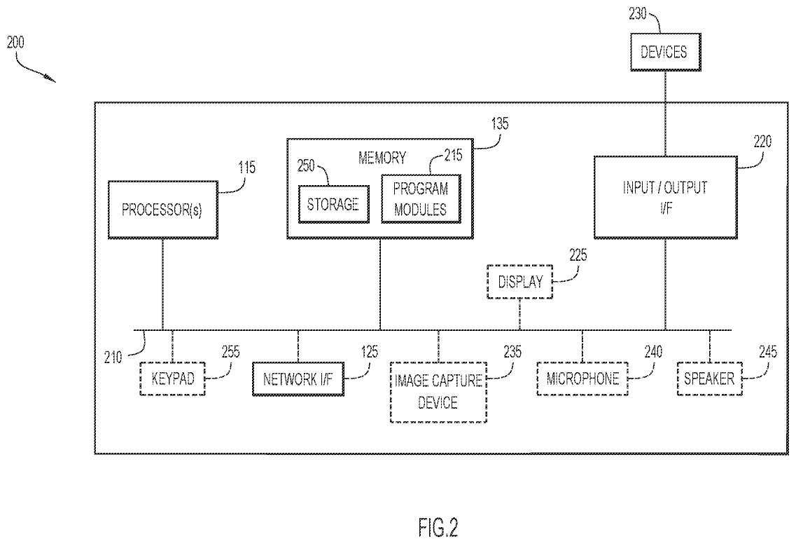

Blockchain systems 140 may each include one or more nodes 144 to implement and maintain at least one corresponding blockchain 142. The nodes may be implemented by any suitable computing devices (e.g., as described below for FIG. 2). The blockchain is generally in the form of a ledger that includes a series of records or blocks chained or linked together. The blockchain is typically managed by a peer-to-peer network (of nodes 144) and used as a distributed ledger. Nodes 144 of the peer-to-peer network communicate and verify new blocks according to a protocol. The peer-to-peer network provides a decentralized approach, where each node has a copy of a blockchain 142. Transactions are transmitted to the peer-to-peer network, where mining nodes (nodes 144) process the transactions. The mining nodes validate a transaction, insert the transaction into a current block, and transmit the block to the other nodes. Blockchain 142 may be implemented by any conventional or other blockchain, and may be a public (e.g., no access restrictions, etc.), private (e.g., restricted access, etc.), or hybrid (e.g., with centralized and decentralized features) blockchain.

Blockchain systems 140 may include one or more distributed or decentralized applications (dApps) 148 to perform various operations (e.g., financial or other transactions related to a blockchain, etc.). The distributed applications (dApps) enable use of access control policies for controlling access to an account and/or data of a user registered with the application by users of specified blockchain identities of various blockchains as described below. In other words, the blockchain identities may be associated with the same and/or various different blockchains (e.g., with respect to the blockchain associated with the application).

Interface module 122 of client systems 114 may further provide a graphical user (e.g., GUI, etc.) or other interface (e.g., command line prompts, menu screens, etc.) that enables users to access distributed applications (dApps) 148 on blockchain systems 140 for performing various operations (e.g., financial or other transactions related to a blockchain, etc.). The interface module may include any conventional or other browser to access the distributed applications (dApps) of blockchain systems 140. The interface module may natively, or include extensions to, access the distributed applications (dApps). The interface module may provide a user interface to serve as a front end for a distributed application (dApp) 148, where back end processing for the distributed application (dApp) is performed on a blockchain system 140. Client systems 114 may further provide reports or notifications pertaining to requests from users (e.g., results of an access request, verification results, etc.).

Server systems 110 may further include one or more blockchain related applications 160 for performing various operations (e.g., financial or other transactions related to a blockchain, etc.). Registration module 116, access module 120, and blockchain related applications 160 may be on the same or different server systems 110. In this case, interface module 122 may further provide a graphical user (e.g., GUI, etc.) or other interface (e.g., command line prompts, menu screens, etc.) that enables users to access blockchain related applications 160 on server systems 110 for performing the various operations (e.g., financial or other transactions related to a blockchain, etc.). The interface module may include any conventional or other browser to access server systems 110.

Resource server systems 150 include a data module 152 that may store and retrieve access control policies including access controls for blockchain identities of users for various blockchains. The resource server systems may provide off-chain storage and access for the access control policies and/or other information (e.g., application data, user information, etc.).

A database system 118 may store various information for the user verification (e.g., login results, access control policies, mappings of blockchain identities to blockchains, etc.). The database system may be implemented by any conventional or other database or storage unit, may be local to or remote from server systems 110, client systems 114, authentication server systems 130, blockchain systems 140, and/or resource server systems 150, and may communicate via any appropriate communication medium (e.g., local area network (LAN), wide area network (WAN), Internet, hardwire, wireless link, Intranet, etc.).

Server systems 110, client systems 114, authentication server systems 130, and resource server systems 150 may be implemented by any conventional or other computer systems preferably equipped with a display or monitor, a base, optional input devices (e.g., a keyboard, mouse or other input device), and any software for use by present invention embodiments (e.g., server/communications software, blockchain software, registration module 116, access module 120, interface module 122, authentication module 132, data module 152, blockchain related applications 160, etc.). The base may include at least one hardware processor 115 (e.g., microprocessor, controller, central processing unit (CPU), etc.), one or more memories 135, and/or internal or external network interfaces or communications devices 125 (e.g., modem, network cards, etc.)).

Registration module 116, access module 120, interface module 122, authentication module 132, data module 152, distributed applications (dApps) 148, and blockchain related applications 160 may include one or more modules or units to perform the various functions of present invention embodiments described below. The various modules (e.g., registration module 116, access module 120, interface module 122, authentication module 132, data module 152, blockchain related applications 160, etc.) may be implemented by any combination of any quantity of software and/or hardware modules or units, and may reside within memory 135 of the server and/or client systems for execution by a corresponding processor 115. The various modules of the blockchain (e.g., distributed applications (dApps) 148, etc.) may be implemented by any combination of any quantity of software and/or hardware modules or units, and may reside on a blockchain 142 for execution by one or more nodes 144.

An example of a computing device 200 for environment 100 (e.g., implementing server systems 110, client systems 114, authentication server systems 130, blockchain systems 140, nodes 144, resource server systems 150, etc.) is illustrated in FIG. 2. The example computing device may perform the functions of present invention embodiments described herein. Computing device 200 may be implemented by any personal or other type of computer or processing system (e.g., desktop, laptop, hand-held device, smartphone or other mobile device, etc.), and may be used for any computing environments (e.g., cloud computing, client-server, network computing, mainframe, stand-alone systems, etc.).

Computing device 200 may include one or more processors 115 (e.g., microprocessor, controller, central processing unit (CPU), etc.), network interface 125, memory 135, a bus 210, and an Input/Output interface 220. Bus 210 couples these components for communication, and may be of any type of bus structure, including a memory bus or memory controller, a peripheral bus, and a processor or local bus using any of a variety of conventional or other bus architectures. Memory 135 is coupled to bus 210 and typically includes computer readable media including volatile media (e.g., random access memory (RAM), cache memory, etc.), non-volatile media, removable media, and/or non-removable media. For example, memory 135 may include storage 250 containing nonremovable, non-volatile magnetic or other media (e.g., a hard drive, etc.). The computing device may further include a magnetic disk drive and/or an optical disk drive (not shown) (e.g., CD-ROM, DVD-ROM or other optical media, etc.) connected to bus 210 via one or more data interfaces.

Moreover, memory 135 includes a set of program modules 215 (e.g., corresponding to registration module 116, access module 120, interface module 122, authentication module 132, data module 152, blockchain software (e.g., distributed applications (dApp) 148, blockchain management software, etc.), blockchain related applications 160, network site or service software, etc.) that are configured to perform functions of present invention embodiments described herein. The memory may further include an operating system, at least one application and/or other modules, and corresponding data. These may provide an implementation of a networking environment.

Input/Output interface 220 is coupled to bus 210 and communicates with one or more peripheral or external devices 230 (e.g., a keyboard, mouse or other pointing device, a display, biometric sensing devices, etc.), at least one device that enables a user to interact with computing device 200, and/or any device (e.g., network card, modem, etc.) that enables computing device 200 to communicate with one or more other computing devices. Computing device 200 may communicate with one or more networks (e.g., a local area network (LAN), a wide area network (WAN), a public network (e.g., the Internet), etc.) via network interface 125 coupled to bus 210.

With respect to certain entities (e.g., client system 114, etc.), computing device 200 may further include, or be coupled to, a touch screen or other display 225, a camera or image capture device 235, a microphone or other sound sensing device 240, a speaker 245 to convey sound, and/or a keypad or keyboard 255 to enter information (e.g., alphanumeric information, etc.). These items may be coupled to bus 210 or Input/Output interface 220 to transfer data with other elements of computing device 200.

Initially, a blockchain (e.g., blockchain 142, etc.) is generally in the form of a ledger that includes a series of records or blocks chained or linked together. Each block includes a hash of the prior block in the blockchain, a timestamp, and transaction information. The hash of the prior block enables the blockchain to be resistant to modification since changes to data in any prior block alter the hash value which propagates to subsequent blocks.

A blockchain is typically managed by a peer-to-peer network and used as a distributed ledger. Nodes of the peer-to-peer network communicate and verify new blocks according to a protocol. The peer-to-peer network provides a decentralized approach, where each node has a copy of the blockchain. Transactions are transmitted to the network, where mining nodes process the transactions. The mining nodes validate a transaction, insert the transaction into a current block, and transmit the block to the other nodes. Various consensus approaches may be used for combining validation results of different mining nodes to determine validity of a transaction (or block).

Users of transactions for the blockchain are authenticated based on cryptographic keys. These keys identify a user and provide access to a user account or wallet. The user wallet is basically an application or software that enables users to store and access digital assets (e.g., for receiving or sending cryptocurrency or other fungible tokens, non-fungible tokens (NFTs), etc.). For example, a non-fungible token (NFT) is a crypto type asset with each token being unique (and representing items, such as digital art, music, or video game items), whereas fungible tokens (e.g., coins of the same cryptocurrency) have the same value of worth and are exchangeable. Each user is associated with their own private key (e.g., accessible only to the associated user, etc.) and a public key (e.g., typically an address on the blockchain). The private and public keys enable authentication of the user based on digital signatures in order to commence a transaction. The user account or wallet typically stores the private key.

For example, in order for the user to send cryptocurrency, a message for a transaction is encrypted with the private key of the user wallet. The private key enables only the user to control the user wallet. A digital signature is created by encrypting the message with the private key, where the digital signature is used to verify the user and transaction. The message may be decrypted with the corresponding public key of the user wallet. Since the private key is unique to the user, successful decryption of the message with the corresponding public key verifies the message was sent by the user. Once verified, the transaction may be posted to the blockchain, thereby adjusting the user wallet based on the transaction.

In addition, a blockchain may store software (e.g., typically referred to as smart contracts) that executes in response to occurrence of pre-defined conditions. A smart contract is generally software or a program that runs on the blockchain. The code and data for the smart contract reside at a specific address on the blockchain. Non-fungible tokens (NFTs) are controlled by smart contracts that handle transference and verification of ownership of the non-fungible tokens (NFTs). A blockchain may be public (e.g., no access restrictions, etc.), private (e.g., restricted access, etc.), or hybrid (e.g., with centralized and decentralized features).

A blockchain domain name is stored on a blockchain. The blockchain domain name may be a non-fungible token (NFT) domain name that is associated with a non-fungible token (NFT) stored in a user wallet. The blockchain domain name may be associated with various information (e.g., wallet addresses, user information (e.g., name, address, email, etc.), data or other access restrictions, etc.). The blockchain domain name is associated with software or smart contracts on the blockchain that may perform various functions (e.g., provide a registry for corresponding wallet addresses, indicate locations of content for the domain (e.g., or a website, etc.) hosted on the blockchain or other system, etc.). In order to access a blockchain domain, the blockchain is accessed to find the record corresponding to the blockchain domain name (which may initiate the corresponding smart contracts for the corresponding functionality). The private key of the user wallet enables the user to have sole control of the blockchain domain name (e.g., authenticating operations or transactions for the blockchain domain name similar to the cryptocurrency example described above, etc.). For example, the user may have sole control to perform operations that alter content and/or functionality for the blockchain domain name.

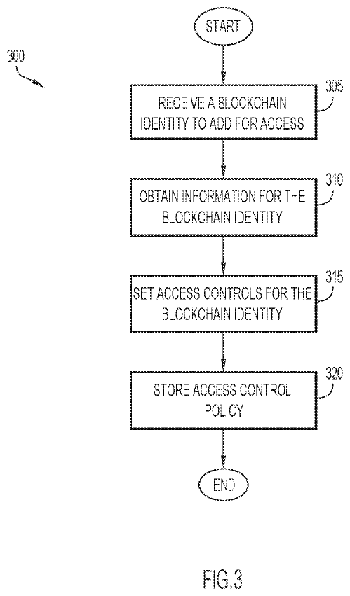

A method 300 of creating access controls for a blockchain identity (e.g., via registration module 116, access module 120, distributed or decentralized application 148, blockchain related application 160, server system 110, client system 114, blockchain system 140, and/or resource server system 150) according to an embodiment of the present invention is illustrated in FIG. 3. Initially, users may register blockchain or other domain names, update a user profile, and/or manage crypto or other assets via registration module 116. The user profile for a user may contain various user information (e.g., name, mailing address, email address, blockchain (or wallet) address of the user, etc.) and be stored on a blockchain 142.

A user desires to share information of an application (e.g., distributed or decentralized application 148 or blockchain related application 160). The user may log in to the application via any conventional or other process (e.g., username/password, wallet verification, etc.). The application may employ an access control mechanism that utilizes an access control policy to control access to the application and/or information of the user to specified one or more users based on blockchain identities. A blockchain identity may include any blockchain entity that is associated with, and/or may be used to identify, a corresponding user (e.g., non-fungible token (NFT) owned by the user, a fungible token owned by the user, a non-fungible token (NFT) domain name of the user, a wallet address for the user, etc.). The access control policy for the application includes access controls for the other users to control their access to the application and/or user information.

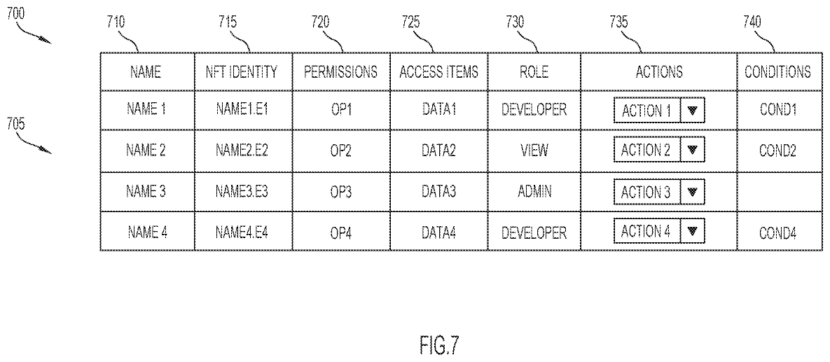

The application (e.g., distributed or decentralized application 148 or blockchain related application 160) receives a blockchain identity from the user at operation 305 for which access controls are to be established and inserted in the access control policy. The blockchain identity may be entered by the user on a user interface of a client system 114 for the application (e.g., as described below for FIG. 7). The blockchain identity corresponds to another user to enable their access to the application and/or information (according to the access control policy).

Information for the blockchain identity may be retrieved at operation 310. The information may be retrieved by the application (e.g., distributed or decentralized application 148 or blockchain related application 160), or by access module 120 based on receiving the blockchain identity from the application. For example, the data for a non-fungible token (NFT) type identity stored on a blockchain (on-chain) is a publicly available and verifiable source of additional information. In the case of non-fungible token (NFT) domains, the data may also be stored external of the blockchain (off-chain) in a database (e.g., database system 118, resource server system 150, etc.) and accessible through scopes or application programming interfaces (APIs) of associated distributed or decentralized applications (dApps) 148 or blockchain related applications 160. A scope basically enables an application to request limited access to a user's data. The scopes may limit data access to publicly available blockchain data and/or private off-chain user added information. Blockchain specific scopes may include a number or value of blockchain tokens, a number or value of non-fungible tokens (NFTs), a number of transactions, and/or an age of transactions. The blockchain scopes are verifiable based on information from the blockchain. User added scopes may also be stored in the associated data of a non-fungible token (NFT) identity. The user scopes are diverse and easily extended, and may include social media handles, associated crypto currency addresses (e.g., pay to accounts), personal details (e.g., name, address, birthday, etc.), contacts (e.g., phone, email, address book, etc.), and/or verifications (e.g., identification check, email/phone verification, etc.).

Once a blockchain identity is entered, information associated with the blockchain identity is retrieved from the blockchain and/or off-chain storage. For example, the blockchain identity may include a non-fungible token (NFT) domain name. A blockchain associated with the non-fungible token (NFT) domain name may be searched for the non-fungible token (NFT) domain name to ascertain the information. The non-fungible token (NFT) domain name (and/or information from the blockchain) may be used to search off-chain storage for the information. The information may include one or more wallet addresses, a display name, an email address, a location, and/or on-chain activity (e.g., based on transactions stored on the blockchain, etc.).

Access controls (e.g., including roles, permissions, indications of items permitted for access, and/or conditions or prerequisites) are provided for the blockchain identity at operation 315. The access controls may be entered by the user on a user interface of a client system 114 for the application (e.g., as described below for FIG. 7). The role indicates a system role of a user (e.g., developer, administrator, viewer, etc.), while permissions or permitted actions indicate the operations the user is allowed to perform (e.g., edit, create, delete, read or view, write, etc.). The role may be associated with predetermined permissions or permitted operations and/or specific items permitted for access. The items (e.g., of digital content, etc.) permitted for access indicate the items for which access is to be granted (e.g., data, user information, operations or functionality, etc.). The conditions or prerequisites indicate the conditions or events for which access specified by the access controls is granted. The prerequisites may indicate logical or other expressions with attributes corresponding to labels or other identifiers of data stored with the information associated with the blockchain identity.

The roles, permissions, and/or items may be based on the information associated with the blockchain identity retrieved from the blockchain and/or off-chain storage. In other words, specific types of verifiable user data may be required for the user to leverage an access control policy. For example, certain on-chain activity may be a prerequisite for granting access to the items indicated for access. By way of example, the user may assign a “write” role to a blockchain identity with a prerequisite that the blockchain identity has a specific kind of crypto token in the wallet of the blockchain identity. The access roles and permissions of the access control policy may be adjusted as the blockchain activity of the user of the blockchain identity changes. For example, transfer of a non-fungible token (NFT) may alter a user status (e.g., remove the user of a blockchain identity from a community, change a number of non-fungible tokens (NFT) pertaining to the community, etc.), where access roles and permissions of the policy may change based on the blockchain activity. Further, the user of a blockchain identity may have view access until the user belongs to a community for a year or other time interval, and greater access may be provided in the policy after the time interval, such as write access.

Further, in the event an identity of the user has been verified through a know your customer (KYC) or similar verification process (e.g., the verification is stored in the information associated with the blockchain identity), the access controls may provide permission for a greater degree of activity. For example, an editor role or permission may be assigned to a verified or trusted user as opposed to a view role or permission for an unverified or untrusted user. A Know Your Customer (KYC) type method generally pertains to verifying a customer identity and assessing risk (e.g., with respect to compliance with Anti-Money Laundering (AML) and other laws, etc.). The method basically requires customers to provide documentation, and includes proof of customer identity, evaluation of a level of risk, and monitoring customer activity patterns.

The proof of customer identity requests information from a customer to prove customer identity, such as a government or other officially issued identification (e.g. driver's or other license, passport, etc.), financial references or statements, information from a consumer or other reporting agency or public database, etc. This may employ proof of identity (with a photograph or image) and proof of address. Proof of address may be shown based on a variety of documents (e.g., passport, driving license, utility bill (electricity, gas, etc.), telephone bill, bank statement, credit card statement, etc.).

The evaluation of a level of risk examines the types of activities or transactions of a customer to determine a risk level that indicates a frequency of monitoring. The monitoring customer activity patterns monitors customer activity or transactions for unusual or outlier activities. The various verifications of the Know Your Customer (KYC) type method may be performed manually and/or automatically by the system (e.g., server system 110 and client system 114, etc.) based on analyzing provided documents and/or comparisons of official identifications to images of users utilizing various conventional or other image processing and/or natural language processing techniques (e.g., comparing an image of a user captured by a client system 114 to an official identification of the user, etc.).

Moreover, the conditions or prerequisites may be based on the information associated with the blockchain identity from the blockchain and/or off-chain storage. For example, access may be granted based on a user having been verified through a know your customer (KYC) or similar verification process (e.g., the verification is stored in the information associated with the blockchain identity). Similarly, a prerequisite may deny access to an unverified user. Further, access may be granted based on a user having a specific type of non-fungible token (NFT) (e.g., digital art, etc.), and/or having a crypto account with a certain balance or value (e.g., above, at, or below a threshold value, such as a balance or value greater than $1000, etc.). Moreover, access may be granted based on a user having a quantity and type of non-fungible tokens (NFTs) (e.g., above, at, or below a threshold quantity, such as greater than 100 total domains, etc.). In addition, access may be granted based on other attributes or combinations of attributes (e.g., age, location, social media presence, email and/or social media account, contacts, etc.) For example, access may be granted to a user over 18 years of age who lives in the U.S. with a verified email and a verified social media account having a threshold quantity of followers (e.g., greater than 10,000 followers, etc.), or to a user with a certain quantity of common contacts (e.g., five or more contacts in common with the registered user of the application, etc.)).

Further, the roles, permissions, and/or items may be determined for the blockchain identity by the application (e.g., distributed or decentralized application 148 or blockchain related application 160) or access module 120 (based on receiving the blockchain identity from the application). These may be based on the information associated with the blockchain identity from the blockchain and/or off-chain storage. For example, an editor role or permission may be assigned to a user that user has been verified through a know your customer (KYC) or similar verification process. The roles, permissions, and/or items may be assigned based on rules indicating conditions for a user and the corresponding role, permissions, and/or items.

The access controls are added or inserted into the access control policy, and the access control policy is stored at operation 320. The access control policy may be updated and stored by the application (e.g., distributed or decentralized application 148 or blockchain related application 160), or by access module 120 based on receiving the access controls and/or access control policy from the application. The stored information may be associated with an application identifier or key and/or registered user information to associate the application and/or registered user with the access control policy (e.g., to differentiate access control policies for different applications and/or registered users, etc.). The access control policy may be stored on the blockchain (or on-chain). On-chain storage has a benefit of transparency for users to be able to determine the blockchain identities (or users) with access to the application. The access control policy may be stored on the blockchain at a blockchain address of the registered user. For example, the access control policy utilizing the blockchain identity for managing authorizations may be stored with the blockchain identity of the registered user. This provides advantages for user maintenance and greater sharing.

Alternatively, the access control policy may be stored in a database or other storage structure (e.g., database system 118, resource server system 150, etc.) external of the blockchain (e.g., as off-chain metadata, etc.). Off-chain storage has an advantage of lower fees and additional privacy. Further, the wallet address or associated information for the blockchain identity may also be stored or persisted with the access control policy (on-chain or off-chain) to enable rapid retrieval.

In addition, the access control policy may use scopes which can be stored with the access control policy on or off-chain in substantially the same manner described above. The scopes may control access to the access control policy by users and/or distributed or other applications.

Once the access controls are established for the blockchain identity in the access control policy, an invitation or communication (e.g., email message, text message, etc.) may be sent to the user of the blockchain identity with a link or indicator (e.g., URL, etc.) to initiate access to the application (e.g., distributed or decentralized application 148 or blockchain related application 160) according to the access control policy. The link may include or indicate the application identifier or key, registered user, and/or other information enabling retrieval of the corresponding access control policy.

Further, one or more blockchain identities may be indicated by a bulk type entry, such as a regular expression (or regex). This type of expression indicates a series of characters that specifies a pattern for text. For example, the regular expression \hat{ }[a-z0-9](\.?[a-z0-9]){5,}\.tld$ may be used to indicate non-fungible token (NFT) domain names having a certain top level domain (tld) as the blockchain identity. In this case, the access controls (e.g., including roles, permissions, indications of items permitted for access, and/or conditions or perquisites) for this expression applies to the domain names indicated by the expression. Since the quantity of domain names corresponding to the expression may be significant, retrieval of information for the domain names to determine the access controls and/or sending communications to the users of the domain names upon entry of the expression may be impractical.

Accordingly, the information retrieval and determining the access controls may be deferred until a corresponding user attempts to access the application (e.g., distributed or decentralized application 148 or blockchain related application 160), thereby enabling the information retrieval and determining of the access controls to be performed on an on-demand type basis. The application (e.g., distributed or decentralized application 148 or blockchain related application 160) or access module 120 may be informed of the attempted access and determine, or notify the user to provide, the desired access controls. The information retrieval, determining of access controls, updating and storage of the access control policy, and access control may be performed in substantially the same manner described above.

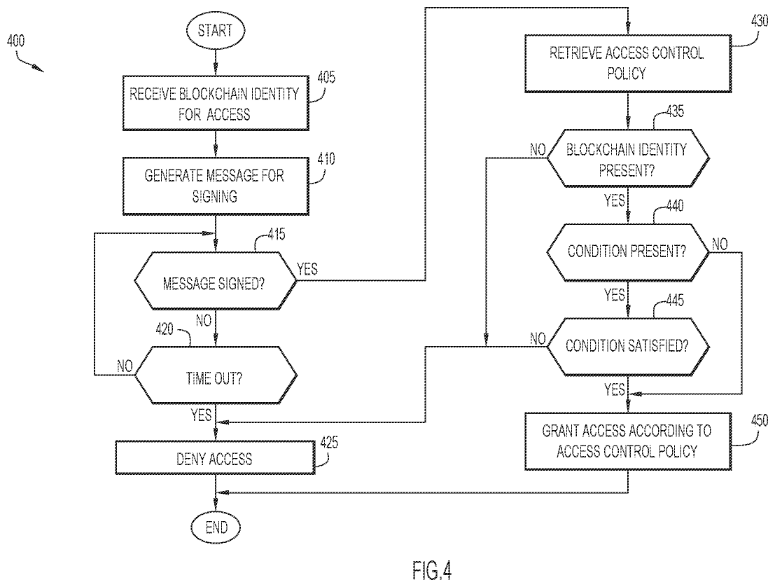

A method 400 of controlling access based on a blockchain identity and an access control policy (e.g., via access module 120, interface module 122, authentication module 132, data module 152, distributed application (dApp) 148 or blockchain related application 160, server system 110, client system 114, authentication system 130, blockchain system 140, and/or resource server system 150) according to an embodiment of the present invention is illustrated in FIG. 4. Initially, an access control policy is created by a registered user of an application (e.g., distributed or decentralized application 148 or blockchain related application 160) for access to that application (and/or items) as described above. The access control policy may include access controls for one or more other users and be stored on a blockchain or in off-chain storage (e.g., database system 118, resource server system 150, etc.) as described above. A user may receive a communication (e.g., email message, text message, etc.) from the registered user (or application) indicating a link or location (e.g., URL, etc.) of the application in order to share information. The user attempts to access the application from a client system 114 (e.g., via interface module 122). Access module 120 receives notification of the attempted access from the application and prompts the user to sign in with a blockchain identity in order to verify the user as corresponding to the blockchain identity for access to the application (and/or shared information).

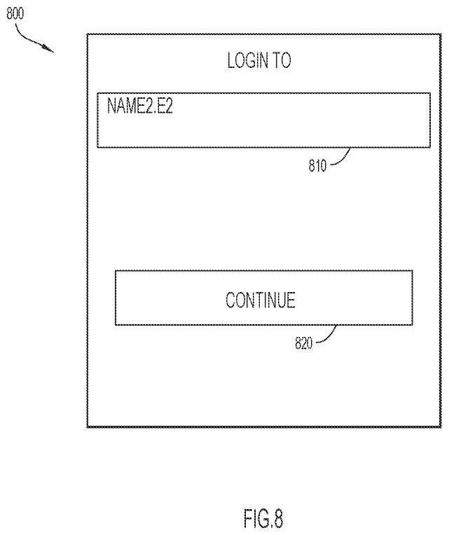

Access module 120 receives the blockchain identity from the user at operation 405. The blockchain identity may be provided on a user interface of client system 114 (e.g., as described below for FIG. 8). The blockchain identity may include any blockchain entity that is associated with, and/or may be used to identify, a corresponding user (e.g., non-fungible token (NFT) owned by the user, a fungible token owned by the user, a non-fungible token (NFT) domain name of the user, a wallet address for the user, etc.). Further, the blockchain identity may include any quantity of terms, words, tokens, or arrangements of any quantity of any types of elements (e.g., alphanumeric or other characters, symbols, numbers, etc.). For example, the blockchain identity may include a name portion and an optional extension (e.g., “name.el”, etc.). Alternatively, the blockchain identity may include the name portion without the extension. The name portion and extension may each include any quantity of terms, words, tokens, or arrangements of any quantity of any types of elements (e.g., alphanumeric or other characters, symbols, numbers, etc.).

Access module 120 verifies the blockchain identity provided by the user. This may be accomplished using conventional or other public/private key encryption techniques. For example, access module 120 may request authentication module 132 of authentication server system 130 to obtain a signed message from the user. In this case, access module 120 accesses the information stored for the blockchain identity on a blockchain and/or in an off-chain database to obtain a wallet address. For example, a blockchain 142 associated with a blockchain identity in the form of a non-fungible token (NFT) domain (via a blockchain system 140) may be accessed to obtain a blockchain (or wallet) address corresponding to the non-fungible token (NFT) domain name provided by the user. The associated blockchain may be determined based on the name (e.g., a blockchain corresponding to an extension, etc.), a mapping of blockchain identities to blockchains, or a blockchain indication received from the user with the blockchain identity. A transaction for the non-fungible token (NFT) domain name may be identified on the associated blockchain, and the blockchain (or wallet) address for the non-fungible token (NFT) domain name may be ascertained from information stored on the associated blockchain for the transaction.

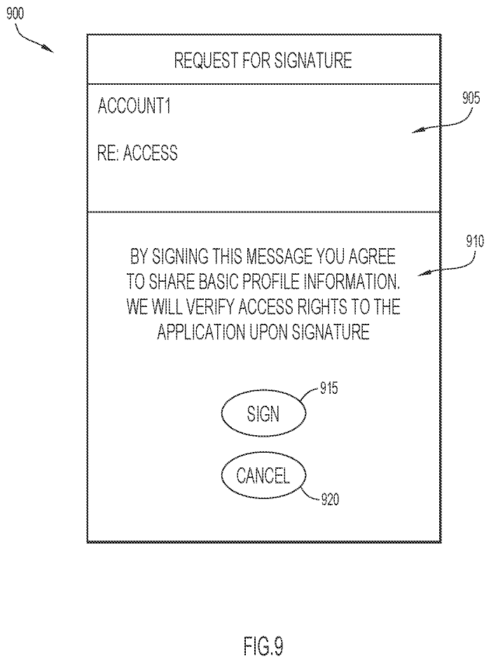

Access module 120 provides the blockchain (or wallet) address for the blockchain identity to authentication module 132. The authentication module generates a message that is sent to the blockchain (or wallet) address for the blockchain identity for the user to sign at operation 410. The user logs in or otherwise accesses the wallet (e.g., via a username and password, wallet verification, etc.) in order to sign the message and verify the user. The signature may be provided on a user interface of client system 114 (e.g., as described below for FIG. 9). Access module 120 monitors the wallet until a successful verification is detected or a time out has occurred (e.g., a time interval has expired, etc.) as determined at operations 415 and 420. The time out may be a predetermined time interval sufficient to enable the user to perform the signing, and preferably in a range from one through five minutes. However, any time interval may be used for the time out.

By way of example, signing of the message in the wallet generates a digital signature of the message based on the private key of the wallet. The signed message or digital signature is decrypted for verification by authentication module 132 based on a public key corresponding to the wallet (e.g., blockchain (or wallet) address, etc.). Since the private key is unique to the wallet, successful decryption of the message with the corresponding public key verifies the message was signed by the user.

When the time out occurs (e.g., the predetermined time interval expires, etc.) without detecting a successful verification as determined at operation 420, the verification of the blockchain (or wallet) address fails. For example, the signed message may have failed the message verification, or the user was unable to access the wallet to sign the message prior to occurrence of the timeout (e.g., expiration of the predetermined time interval, etc.). When the verification fails, the access is denied at operation 425. A message may be provided to the user indicating the failed verification, and may further indicate a reason for the failure (e.g., timeout, invalid digital signature, etc.).

When the verification is successful prior to occurrence of the timeout (e.g., expiration of the predetermined time interval, etc.) as determined at operation 415, the user is determined to be associated with the blockchain (or wallet) address. The signing of the message by the user verifies the user as the owner of the wallet (and as corresponding to the blockchain identity).

Once the verification is successful, access module 120 retrieves the corresponding access control policy at operation 430. The access control policy may be stored on a blockchain or in off-chain storage (e.g., database system 118, resource server system 150, etc.) as described above, and retrieved based on an identifier or key associated with the application (e.g., distributed or decentralized application 148 or blockchain related application 160) and/or information associated with the registered user (e.g., wallet address, etc.). The key and information associated with the registered user are accessible or known to the application, and may be provided to the access module. For example, the registered user information may be indicated in a login request from the URL or link in the communication, and/or may be provided by the user in a login request (e.g., a registered user blockchain identity which can be used to ascertain the wallet address, etc.). The access control policy indicates access controls for blockchain identities including a role, permission, indications of items permitted for access, and/or a condition or prerequisite for granting access.

Access module 120 examines the access control policy for the presence of the blockchain identity. When the blockchain identity is not present in the access control policy as determined at operation 435, the access is denied at operation 425. A message may be provided to the user indicating the failed access, and may further indicate a reason for the failure (e.g., lack of access rights, unauthorized user, etc.).

When the blockchain identity is present in the access control policy as determined at operation 435, access module 120 determines a presence of a condition or prerequisite for the blockchain identity in the access control policy. When a condition or prerequisite exists as determined at operation 440, access module 120 retrieves the corresponding information (e.g., attributes, etc.) from a blockchain or off-chain storage (e.g., database system 118, resource server system 150, etc.) to determine satisfaction of the condition. The condition or prerequisite may be based on the information associated with the blockchain identity from the blockchain and/or off-chain storage. For example, the condition or prerequisite may be based on the user having been verified through a know your customer (KYC) or similar verification process, having a specific type of non-fungible token (NFT) (e.g., digital art, etc.), having a crypto account with a certain balance or value, having a quantity of non-fungible tokens (NFTs), and/or other attributes or combinations of attributes (e.g., age, location, social media presence, email and/or social media account, contacts, etc.).

When the condition is not satisfied as determined at operation 445, the access is denied at operation 425. A message may be provided to the user indicating the failed verification, and may further indicate a reason for the failure (e.g., failure to satisfy a prerequisite, etc.).

When the condition does not exist or is satisfied as determined at operations 440, 445, access is granted to the user at operation 450. This may be accomplished by access module 120 informing the application (e.g., distributed or decentralized application 148 or blockchain related application 160) to grant access to the user according to the access controls for the blockchain identity indicated in the access control policy. The application restricts user access in accordance with the role, permission, and indication of items permitted for access of the access control policy for the blockchain identity associated with the user. This may be accomplished using any conventional or other access control techniques.

In addition, when the blockchain identity is associated with a bulk type entry (e.g., regular expression, etc.) in the access control policy, the corresponding access controls may not yet be indicated. In this case, the application (e.g., distributed or decentralized application 148 or blockchain related application 160) or access module 120 may be informed of the attempted access and determine, or notify the user to provide, the desired access controls. Information may be retrieved for the blockchain identity in order to determine and insert the access controls in the access control policy and store the access control policy in substantially the same manner described above. The application grants access to the user according to the access control policy in substantially the same manner described above.

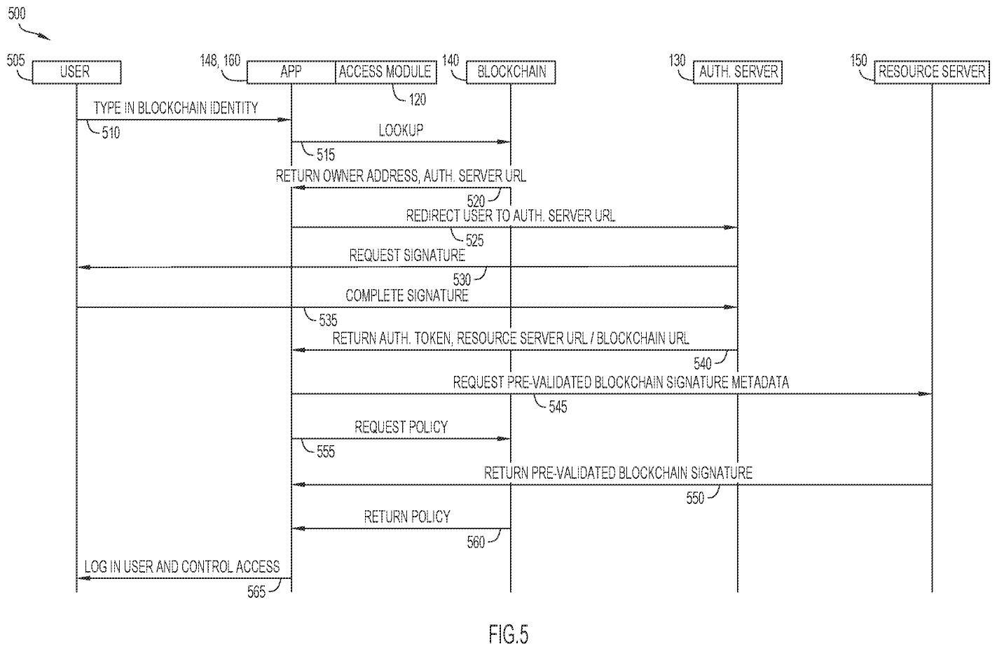

A method 500 of granting and controlling access based on a blockchain identity and an access control policy (e.g., via access module 120, interface module 122, authentication module 132, data module 152, distributed application (dApp) 148 or blockchain related application 160, server system 110, client system 114, authentication system 130, blockchain system 140, and/or resource server system 150) according to an embodiment of the present invention is illustrated in FIG. 5. Initially, an access control policy is created by a registered user of an application (e.g., distributed or decentralized application 148 or blockchain related application 160) for blockchain identities of users for access to that application (and/or data) as described above. The access control policy may include access controls for one or more users (e.g., including a user 505), and may be stored on a blockchain or in off-chain storage (e.g., database system 118, resource server system 150, etc.) as described above.

User 505 may receive a communication (e.g., email message, text message, etc.) from the registered user (or application) indicating a link or location (e.g., URL, etc.) of the application (e.g., distributed or decentralized application 148 or blockchain related application 160) in order to share information. The user attempts to access the application from a client system 114 (e.g., via interface module 122). The application (or access module 120) prompts the user for a blockchain identity. The user provides the blockchain identity (via client system 114) to the application (or access module 120) at flow 510.

The blockchain identity may include any blockchain entity that is associated with, and/or may be used to identify, a corresponding user (e.g., non-fungible token (NFT) owned by the user, a fungible token owned by the user, a non-fungible token (NFT) domain name of the user, a wallet address for the user, etc.). Further, the blockchain identity may include any quantity of terms, words, tokens, or arrangements of any quantity of any types of elements (e.g., alphanumeric or other characters, symbols, numbers, etc.). For example, the blockchain identity may include a name portion and an optional extension (e.g., “name.el”, etc.). Alternatively, the blockchain identity may include the name portion without the extension. The name portion and extension may each include any quantity of terms, words, tokens, or arrangements of any quantity of any types of elements (e.g., alphanumeric or other characters, symbols, numbers, etc.).

Access module 120 accesses a blockchain 142 associated with the blockchain identity (via a blockchain system 140), and performs a lookup for the blockchain identity at flow 515. The associated blockchain may be determined based on the name (e.g., a blockchain corresponding to an extension, etc.), a mapping of blockchain identities to blockchains, or a blockchain indication received from the user with the name of the blockchain identity. For example, a transaction for a blockchain identity in the form of a non-fungible token (NFT) domain may be identified on the associated blockchain based on the name of the non-fungible token (NFT) domain, and the blockchain (or wallet) address for the non-fungible token (NFT) domain may be ascertained from information stored on the associated blockchain for the transaction.

The blockchain system returns a blockchain (or wallet) address of the user corresponding to the blockchain identity and a uniform resource locator (URL) or address of authentication server system 130 at flow 520. The application (or access module 120) redirects user 505 (or client system 114) to the authentication server system at flow 525 to verify the user corresponds to the blockchain identity. This may be accomplished using conventional or other public/private key encryption techniques. For example, the application (or access module 120) may provide authentication module 132 of authentication server system 130 the blockchain (or wallet) address of the user corresponding to the blockchain identity in order to obtain a signed message from the user. In this case, the authentication module generates a message that is sent to the wallet of the blockchain identity for the user to sign at flow 530 in substantially the same manner described above. User 505 signs the message at flow 535 by accessing a user account associated with the wallet. The signing of the message by the user verifies the user as corresponding to the blockchain identity in substantially the same manner described above.

Authentication module 132 of authentication server system 130 provides to the application (or access module 120) a token indicating the user verification for the blockchain identity and a uniform resource locator (URL) or address of a resource server system 150 storing the corresponding access control policy at flow 540. The application (or access module 120) requests the access control policy from data module 152 of resource server system 150 at flow 545. The application further provides the token from the authentication server system to verify the user as corresponding to the blockchain identity to the resource server system. The data module retrieves and provides the requested access control policy to the application (or access module 120) at flow 550. The access control policy may be retrieved based on an identifier or key associated with the application and/or information associated with the registered user (e.g., wallet address, etc.). The key and information associated with the registered user are accessible or known to the application, and may be provided to the access module (and data module). For example, the registered user information may be indicated in a login request from the URL or link in the communication, and/or may be provided by the user in a login request (e.g., a registered user blockchain identity which can be used to ascertain the wallet address, etc.).

Alternatively, the access control policy may be stored on a corresponding blockchain 142 (e.g., of the registered user, etc.). In this case, authentication module 132 of authentication server system 130 provides to the application (or access module 120) a token indicating the user verification and a uniform resource locator (URL) or other indicator of a blockchain system 140 storing the access control policy at flow 540. The application (or access module 120) requests the access control policy from blockchain system 140 at flow 555. The application (or access module 120) further provides the token from the authentication server system to verify the user as corresponding to the blockchain identity to the blockchain system. The blockchain system retrieves and provides the requested access control policy to the application (or access module 120) at flow 560. The access control policy may be retrieved based on an identifier or key associated with the application and/or information associated with the registered user (e.g., wallet address, etc.). The key and information associated with the registered user are accessible or known to the application, and may be provided to the access module (and blockchain system). For example, the registered user information may be indicated in a login request from the URL or link in the communication, and/or may be provided by the user in a login request (e.g., a registered user blockchain identity which can be used to ascertain the wallet address, etc.).

The application notifies user 505 (via client system 114) of a successful login, and proceeds to grant access at flow 565. The access is restricted to the items permitted for access and the role and permission indicated for the blockchain identity in the access control policy. This may be accomplished using any conventional or other access control techniques. For example, a view permission enables the user to view or read data (without writing or changing the data), while an edit permission enables the user to read, write and modify data.

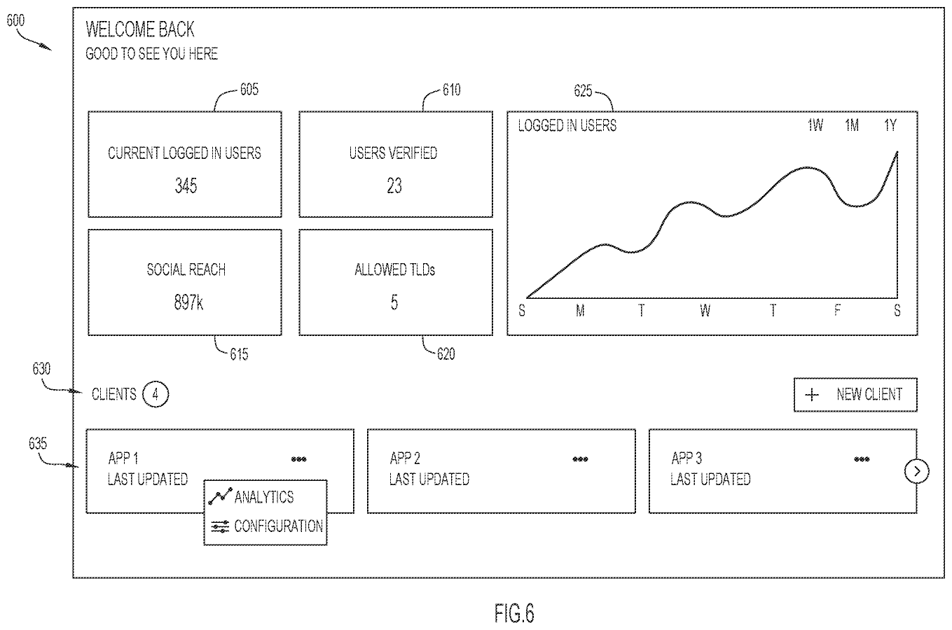

Operation of an embodiment of the present invention for an example scenario is described with respect to FIGS. 6-9. Initially, information pertaining to users of a distributed or decentralized application (dApp) of a developer may be collected by a service. The information may be provided on a user interface 600 (FIG. 6). The user interface may include an area 605 indicating a quantity of users logged in to the distributed application, an area 610 indicating a quantity of verified users, an area 615 indicating a quantity of users reached or a social reach, an area 620 indicating a quantity of allowed top level domains, an area 625 indicating graphically a quantity of logged in users over a period of time, an area 630 indicating a quantity of clients, and an area 635 indicating a status of distributed applications.

The developer shows the information to a team member who desires to better understand how different campaigns are affecting login and usage of the distributed application. The team member requests the developer to add the team member to the developer account of the service for access to the data. The developer accesses a user interface 700 (FIG. 7) of an administration section of the service and adds a blockchain identity in the form of a non-fungible token (NFT) domain name of the team member to an access control policy for the account (or service).

By way of example, user interface 700 displays an access control policy or table 705 with columns or fields for information including a name field 710, an NFT identity field 715, a permissions field 720, an access field 725, a role field 730, an actions field 735, and a conditions field 740. Name field 710 indicates a user name for access (e.g., NAME1-NAME 4 as shown in FIG. 7). NFT identity field 715 indicates an NFT identity (or domain name) (e.g., NAME1.E1, NAME2.E2, NAME3.E3, and NAME4.E4 as shown in FIG. 7). Permissions field 720 indicates permitted operations or actions (e.g., OP1-OP4 as shown in FIG. 7, such as edit, create, delete, read or view, write, etc.). Access field 725 indicates the data or other items permitted for access (e.g., DATA1-DATA4 as shown in FIG. 7). The data or other items may include any data, account, functionality, code, and/or operation, and may be indicated by any identifiers or labels (e.g., used by the application, etc.) corresponding to those items. Role field 730 indicates a role of a user (e.g., developer, administrator, view only, etc.). The role may be associated with predetermined permission or permitted operations and/or items to access, which may be modified by the permissions in field 720 and access indications in field 725. Actions field 735 indicates actions for the user to perform on entries in table 705 (e.g., ACTION1-ACTION4 as shown in FIG. 7, such as edit, delete, etc.). For example, a user may change roles, permissions or items to access for an entry, or delete the entry. Conditions field 740 indicates conditions or prerequisites for granting access (e.g., COND1, COND2, and COND4 as shown in FIG. 7). The conditions or prerequisites may indicate any logical or other expressions with attributes corresponding to labels or other identifiers of data associated with the blockchain identity.

The developer adds information for the team member in table 705, and may grant “view” rights to prevent the user from changing data (e.g., the developer clientid, settings for an integration, etc.). The developer sends the team member a communication with a uniform resource locator (URL) to login and access the information.

The team member actuates a link for the URL in the communication which provides a user interface 800 (FIG. 8). By way of example, user interface 800 includes a field 810 to receive a blockchain identity and a continue actuator 820. The team member enters a corresponding blockchain identity (e.g., NFT domain name, etc.) in field 810 (e.g., NAME2.E2 as shown in FIG. 8), and actuates continue actuator 820 to initiate access. A signature request is initiated for the login flow for the wallet associated with the blockchain identity. The team member accesses the wallet and views a user interface 900 (FIG. 9) to sign the message. By way of example, user interface 900 includes an account area 905 indicating account information, a message area 910 indicating a message, an actuator 915 to sign the message, and an actuator 920 to cancel the action.

The team member actuates actuator 915 to sign the message. Once the message is signed, the conditions or prerequisites are verified and the team member is granted access to the application to view the data according to the role, permissions, and items for access indicated for the blockchain identity in the access control policy.

Present invention embodiments may provide various technical and other advantages. For example, present invention embodiments provide enhanced security and access control. By way of example, verification for granting access may use private keys of blockchains to verify the user. Moreover, a single blockchain identity may be used as a universal login credential (e.g., non-fungible token (NFT) domain name, etc.), thereby streamlining access grants and providing an enhanced user experience. In addition, present invention embodiments may provide any items, permissions, and/or conditions to indicate with specificity particular items, users, and/or groups of users to grant access, thereby limiting access to intended data and/or recipients.

The access control policy of the present invention embodiments is not limited to the scenarios described above, and may be applied to control access to any information and/or entities. For example, the access control policy may be used to control access to applications, control access to data or information, define a routing matrix controlling bridging of different types of communication channels and/or users, control use of user communication medium preferences, control use of notifications (e.g., control senders and receivers, etc.), etc.

It will be appreciated that the embodiments described above and illustrated in the drawings represent only a few of the many ways of implementing embodiments for access control using a blockchain identity and policy based authorization. In addition, characteristics or features of embodiments of the present invention may be combined in any fashion to provide additional embodiments of the present invention.

The environment of the present invention embodiments may include any number of computer or other processing systems (e.g., client or end-user systems, server systems, blockchain systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, hand-held devices, smartphones or other mobile devices, etc.), and may include any commercially available operating system and any combination of commercially available and custom software (e.g., communications software; server software; software of present invention embodiments (including registration module 116, access module 120, interface module 122, authentication module 132, distributed applications (dApps) 148, data module 152, blockchain related applications 160, etc.); etc.). These systems may include any types of monitors and input devices (e.g., keyboard, mouse, voice recognition, etc.) to enter and/or view information.

It is to be understood that the software of the present invention embodiments (e.g., registration module 116, access module 120, interface module 122, authentication module 132, distributed applications (dApps) 148, data module 152, blockchain related applications 160, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client, server, authentication, blockchain, and resource systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., registration module 116, access module 120, interface module 122, authentication module 132, distributed applications (dApps) 148, data module 152, blockchain related applications 160, etc.) may be available on a non-transitory computer useable or readable medium (e.g., magnetic or optical mediums, magneto-optic mediums, CD-ROM, DVD, memory devices, etc.) of a stationary or portable computer program product, apparatus, or device for use with stand-alone systems or systems connected by a network or other communications medium. The computer useable or readable medium (or media) may include instructions executable by one or more processors to perform functions of present invention embodiments described herein.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., login results, metadata associated with blockchain verifications, mappings of blockchain identities to blockchains, etc.). The database system may be implemented by any number of any conventional or other databases, data stores or storage structures to store information. The database system may be included within or coupled to the server, client, authentication, blockchain, and/or resource systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., results of an access request, verification results, name and/or other attributes of a blockchain identity, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The report may include any information arranged in any fashion, and may be configurable based on rules or other criteria to provide desired information to a user (e.g., results of an access request, verification results, etc.).

The present invention embodiments are not limited to the specific tasks or algorithms described above, but may be utilized for controlling access to any applications, services, data sources, data, functionalities, code, and/or platforms based on an access control policy employing blockchain identities.

The present invention embodiments may process access requests from any entity (e.g., user, application, service, computing or other device, etc.), and utilize any blockchain identity to access any computer related or other items (e.g., applications, services, data sources, data, functionalities, operations, code, accounts, platforms, etc.). A blockchain identity may include any blockchain entity or asset that is associated with, and/or may be used to identify, a corresponding user (e.g., non-fungible token (NFT) owned by the user, a fungible token owned by the user, a non-fungible token (NFT) domain name of the user, a wallet address for the user, etc.). The asset may correspond to various items (e.g., blockchain or other domain name, digital art, music, video game items, non-fungible tokens (NFTs), fungible tokens, etc.). The blockchain identity may be indicated by any name or identifier including any quantity of terms, words, tokens, or arrangements of any quantity of any types of elements (e.g., alphanumeric or other characters, symbols, numbers, etc.). The name or identifier preferably includes a name or identifier portion and an optional extension (e.g., “name.el”, etc.). Alternatively, the name or identifier may include the name or identifier portion without the extension. The name and/or extension may be used for partial or exact matching for name lookups (e.g., to obtain blockchain (or wallet) addresses and/or other attributes, etc.). The name or identifier portion and extension may each include any quantity of terms, words, tokens, or arrangements of any quantity of any types of elements (e.g., alphanumeric or other characters, symbols, numbers, etc.)

Any quantity of any blockchain, user or other attributes may be associated with a blockchain identity. The user corresponding to a blockchain identity (or wallet address) may be verified in any manner (e.g., signing a message, user verification, encryption/decryption, username/password, etc.).

The access control policy may include any information arranged in any fashion (e.g., items to access, roles, permissions, conditions, blockchain entity, etc.). The access control policy may be associated with a user or application via any information (e.g., application identifiers or keys, registered user information, etc.). The access control policy may be stored on a blockchain and/or an off-chain data source. The data source may include any storage structure (e.g., decentralized storage structure or platform, blockchain storage, database, etc.). The access control policy may be associated with a registered user and/or application in any fashion, and may be stored and retrieved based on any information (e.g., based on registered user information (e.g., wallet address, blockchain identity, user name, etc.), application identifier or key, etc.). The access control policy may be stored on the blockchain at any desired address (e.g., wallet or other address associated with the registered user, application, a designated user or administrator, etc.).

The roles may include any user roles, and may correspond to any permitted operations and/or items. The permissions may include any operations performed on the items (e.g. write, read or view, change, edit, delete, create, etc.). Access may be granted to any digital content. The digital content may include any items for access (e.g., data, multimedia or other content, functionality, operation, code, account, etc.). The conditions may be provided in any format, and may include any desired conditions or events with respect to any information or attributes (e.g., blockchain activity, user attributes, etc.). The access control policy may identity users based on any blockchain entities or assets. The blockchain identities may be from any desired blockchains, and may be from the same and/or different blockchains. For example, access may be granted to items for blockchain identities from the same or different blockchains.

Having described preferred embodiments of a new and improved system, method, and computer program product for access control using a blockchain identity and policy based authorization, it is believed that other modifications, variations and changes will be suggested to those skilled in the art in view of the teachings set forth herein. It is therefore to be understood that all such variations, modifications and changes are believed to fall within the scope of present invention embodiments as defined by the appended claims.

What is claimed is:

1. A method of controlling access to digital content comprising:
verifying, via at least one processor, a blockchain identity associated with a user, wherein an access control policy indicates blockchain identities of one or more users for controlling access to the digital content of a different user;
verifying, via the at least one processor, the user against the access control policy; and
granting to the user, via the at least one processor, access to the digital content of the different user in accordance with the access control policy.

2. The method of claim 1, wherein the blockchain identity corresponds to a blockchain domain name.

3. The method of claim 1, wherein verifying the blockchain identity comprises:
sending a message to a blockchain address of a blockchain associated with the blockchain identity; and
detecting signing of the message by the user.

4. The method of claim 1, wherein the access control policy is adjusted based on blockchain activity by the user.

5. The method of claim 1, wherein the access control policy indicates one or more permitted actions for the user, and granting access to the digital content of the different user further comprises:
restricting access of the user to performing the one or more permitted actions on the digital content of the different user.

6. The method of claim 5, wherein the one or more permitted actions are determined based on a verification of an identity of the user.

7. The method of claim 1, wherein the access control policy indicates a condition for the user, and verifying the user against the access control policy comprises:
determining that the user satisfies the condition.

8. The method of claim 7, wherein the condition includes a threshold level of activity on a blockchain by the user.

9. A system for controlling access to digital content comprising:
one or more memories; and
at least one processor coupled to the one or more memories, the at least one processor configured to:
verify a blockchain identity associated with a user, wherein an access control policy indicates blockchain identities of one or more users for controlling access to the digital content of a different user;
verify the user against the access control policy; and
grant to the user access to the digital content of the different user in accordance with the access control policy.

10. The system of claim 9, wherein the blockchain identity corresponds to a blockchain domain name.

11. The system of claim 9, wherein verifying the blockchain identity comprises:
sending a message to a blockchain address of a blockchain associated with the blockchain identity; and
detecting signing of the message by the user.

12. The system of claim 9, wherein the access control policy is adjusted based on blockchain activity by the user.

13. The system of claim 9, wherein the access control policy indicates one or more permitted actions for the user, and granting access to the digital content of the different user further comprises:
restricting access of the user to performing the one or more permitted actions on the digital content of the different user.

14. The system of claim 13, wherein the one or more permitted actions are determined based on a verification of an identity of the user.

15. The system of claim 9, wherein the access control policy indicates a condition for the user, and verifying the user against the access control policy comprises:
determining that the user satisfies the condition.

16. The system of claim 15, wherein the condition includes a threshold level of activity on a blockchain by the user.

17. A computer program product for controlling access to digital content, the computer program product comprising one or more computer readable media having instructions stored thereon, the instructions executable by at least one processor to cause the at least one processor to:
verify a blockchain identity associated with a user, wherein an access control policy indicates blockchain identities of one or more users for controlling access to the digital content of a different user;
verify the user against the access control policy; and
grant to the user access to the digital content of the different user in accordance with the access control policy.

18. The computer program product of claim 17, wherein the blockchain identity corresponds to a blockchain domain name.

19. The computer program product of claim 17, wherein verifying the blockchain identity comprises:
sending a message to a blockchain address of a blockchain associated with the blockchain identity; and
detecting signing of the message by the user.

20. The computer program product of claim 17, wherein the access control policy is adjusted based on blockchain activity by the user.

21. The computer program product of claim 17, wherein the access control policy indicates one or more permitted actions for the user, and granting access to the digital content of the different user further comprises:
restricting access of the user to performing the one or more permitted actions on the digital content of the different user.

22. The computer program product of claim 21, wherein the one or more permitted actions are determined based on a verification of an identity of the user.

23. The computer program product of claim 17, wherein the access control policy indicates a condition for the user, and verifying the user against the access control policy comprises:
determining that the user satisfies the condition.

24. The computer program product of claim 23, wherein the condition includes a threshold level of activity on a blockchain by the user.
